(19) United States
(12) Patent Application Publication
(10) Pub. No.: US 2014/0197139 A1
(43) Pub. Date: Jul. 17, 2014

(54) PRODUCTION OF FINE GRAINS IN DEPOSITION WELDING

(71) Applicant: SIEMENS AKTIENGESELLSCHAFT, Munchen (DE)

(72) Inventors: Bernd BURBAUM, Falkensee (DE); Torsten JOKISCH, Neuenhagen bei Berlin (DE)

(73) Assignee: SIEMENS AKTIENGESELLSCHAFT, Munchen (DE)

(21) Appl. No.: 14/152,327

(22) Filed: Jan. 10, 2014

(30) Foreign Application Priority Data
Jan. 11, 2013 (EP) 13150979

(51) Int. Cl. B23K 26/34

(52) U.S. Cl. CPC B23K 26/345
USPC 219/76.12; 219/121.64

(57) ABSTRACT

By tilting a welding nozzle back and forth for depositing each successively applied weld layer, a very fine-grained structure is achieved in the multilayered buildup of material producing a directionally solidified structure.

### CROSS-REFERENCE TO RELATED APPLICATIONS

The present application claims priority of European Patent Application No. 13150979.6, filed Nov. 1, 2013, the contents of which are incorporated by reference herein.

### FIELD OF THE INVENTION

The invention relates to laser deposition welding, in particular applied on a directionally solidified structure, with the intention of achieving fine globular grains.

### TECHNICAL BACKGROUND

Excessively large or excessively long grains in a casting or in a weld are undesirable.

It is therefore an object of the invention to solve the aforementioned problem and particularly to produce relatively shorter grains in a weld.

In deposition welding, it is desired that the grain structure changes in each weld layer deposited, so that this grain structure becomes visible in a metallographically prepared section as a kind of “checkerboard pattern”.

The structure is created by providing, during the welding of each layer, the lower part of the layer, i.e. the part furthest from the laser beam source, grows epitaxially on the base material, whereas the upper part of the layer undergoes polycrystalline solidification with a different crystallographic orientation. When welding each next layer, only this last, polycrystalline-solidified region of the previous layer may be caused to begin melting again, so that only the upper region of the grain structure continues to grow. This structure reduces the susceptibility of the microstructure to cracking during the welding and subsequent heat treatment, since the stresses can be distributed over many small grain boundaries.

To produce this structure, the process parameters (laser power, laser beam diameter, powder mass flow, traversing speed) must be kept within very close tolerances. Especially when there is an increase in the traversing speed of the welding beam on the layer, the checkerboard pattern is increasingly lost.

### SUMMARY OF THE INVENTION

It is proposed to adjust the inclination of a welding beam or a laser beam used for the welding and the coaxial powder feed alternately after each layer by preferably 30°+/−5° in relation to a perpendicular to the surface.

The melt respectively solidifies in the direction of the laser radiation on account of the temperature gradient in the direction of the molten bath or the laser radiation. By changing the angle of inclination of the welding beam preferably after each layer has been welded, new grain growth should be started each time, corresponding approximately to the height of the layer. A long, continuous or columnar grip is thereby avoided.

### BRIEF DESCRIPTION OF THE DRAWINGS

FIG. 1 shows a schematic representation of the invention.

### DESCRIPTION OF AN EMBODIMENT

The FIGURE and the description only present exemplary embodiments.

The FIGURE schematically shows the procedure for depositing layer after layer on a substrate 4, in particular a substrate with a directionally solidified structure.

It is only by way of example that the invention is explained on the basis of laser deposition welding.

An appropriate welding nozzle 7 is used to deposit material on a substrate 4. The substitute preferably has a directionally solidified structure. The deposited material is typically in powder form, as known in the art. The welding beam passes out the same nozzle as the powder and is preferably beamed in the same direction as the powder is sprayed and so begins heating of the powder as it is sprayed out the nozzle.

In this embodiment, the laser, or a center axis of the laser beam 20, has a specific first angle α1 in relation to a perpendicular 16 to the surface of the substrate 4. That first angle differs significantly from 0° and from 90°. Significantly means that this angle is greater than a matter of tolerances of a 0° or 90° angle. In an embodiment this angle α1 is preferably 30°.

After a first weld layer 13′ has been deposited by the nozzle 7 in a first tilt direction, the welding nozzle 7 is tilted to a second angle α2 in a second tilt direction for depositing a next deposited second weld layer in the next deposited following plane 13″ above the plane of the first weld layer 13′. The tilt of the nozzle is along the path of relative motion of the laser beam over the preceding weld layer 13′. The tilt of the nozzle and particularly of the weld beam from the nozzle is here shown as being to the other side of the perpendicular to the surface of the weld layer 13′ to the second angle α2 in relation to the perpendicular to the surface. In this example, the new tilt angle is the same angle absolutely as the angle at which the previous layer was deposited, that is α2=−α1 or 360°−α1.

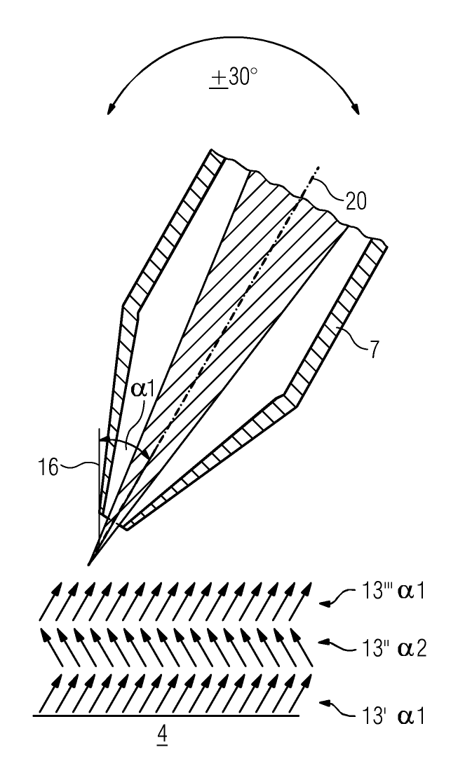

The different tilt angles is schematically shown in the FIG. 1 by the different directions of the arrows in the individual layers 13′, 13″, 13′″, . . . , which indicate the alignment of the laser beam 20 and of the powder being sprayed in relation to the substrate 4. The arrows representing each of the weld layers 13′, 13″, . . . preferably lie in the plane of the drawing.

Each weld layer 13′, 13″, . . . may be formed by multiple weld tracks. The weld tracks of the weld layers 13′, 13″, 13′″ of the directly superjacent weld layers 13′ and 13″ or 13″ and 13′″ preferably run parallel to one another at a common angle within each layer.

The tilting back and forth of the welding beam in relation to the surface of the substrate 4 or the underlying weld layer 13″, 13′″, . . . is preferably continued for every further weld layer 13″ deposited.

In a weld, the powder at the weld, which is melted by the weld beam, solidifies in the direction of the beam radiation, because that direction is influenced by the vector of the temperature gradient generated by the weld beam. The weld solidifies from the bottom of the weld (at the side away from the weld beam) because the bottom is the coldest part of the melt. Tilting of the nozzle also tilts the temperature gradient of the weld layers at the same tilt angle. The grain of weld produced is not a single direction or columnar grain, but rather is a successive series of shorter grain columns, each matching the weld beam tilt angle. The disruption along the grains should strengthen the weld, as a longer grain column may weaken a weld.

The method is preferably used in the case of a laser welding process.

The directionally solidified substrate 4 is preferably produced from nickel-based superalloys and has monocrystalline or columnar-solidified longitudinal grains, and polycrystalline welding points are produced in the substrate.

By the method, fine structures are produced in the material built up and there is no promotion of crack growth between large and small grains.

What is claimed is:

1. A method for deposition welding of a substrate, which has a directionally solidified structure, the method comprising,
holding a welding nozzle at a selected angle (α1, α2) relative to a perpendicular to a surface of the substrate wherein the selected angle differs significantly from 0° and
producing a first weld layer at a first tilt angle (α1) in relation to the perpendicular to the surface that is different from 0° and
then producing a second weld layer at a second tilt angle (α2) in relation to the perpendicular to the surface that is significantly different from 0° and significantly different from the first angle (α1).

2. The method as claimed in claim 1, in which the directionally solidified structure has a columnar-solidified structure.

3. The method as claimed in claim 1, in which the directionally solidified structure has a monocrystalline structure.

4. The method as claimed in claim 1, using a laser deposition welding.

5. The method as claimed in claim 1, further comprising the first angle (α1) with respect to the perpendicular to the surface is 30°+/−5°.

6. The method as claimed in claim 5, further comprising the second weld layer is welded at the second angle (α2) which is (360°−α1) with respect to the perpendicular to the surface of the preceding weld layer (13′, 13″, . . . ).

7. The method as claimed in claim 1, further comprising tilting the welding nozzle in repeated alternation about the perpendicular to the surface, alternating between the first and second angles.

8. The method as claimed in claim 1, in which a polycrystalline welding point is produced.

9. The method as claimed in claim 7, wherein all first angles are the same angles and all second angles are the same angles.
